(19) United States
(12) Patent Application Publication
(10) Pub. No.: US 2024/0276264 A1
(43) Pub. Date: Aug. 15, 2024

(54) METHOD OF OBTAINING A REPEATING SCHEDULING PATTERN AND METHOD OF CONDUCTING A TEST ON A DEVICE UNDER TEST

(71) Applicant: Rohde & Schwarz GmbH & Co. KG, Munich (DE)

(72) Inventor: Francesco ROSSETTO, Munich (DE)

(73) Assignee: Rohde & Schwarz GmbH & Co. KG, Munich (DE)

(21) Appl. No.: 18/166,679

(22) Filed: Feb. 9, 2023

(51) Int. Cl. H04W 24/10; H04L 5/00; H04W 24/08

(52) U.S. Cl. CPC H04W 24/10; H04L 5/0007; H04W 24/08

(57) ABSTRACT

The present disclosure provides a method of obtaining a repeating scheduling pattern for testing a device under test by a mobile communication tester. A network configuration for performing a wireless communication test on the device under test is inputted. At least one key performance indicator is provided. The network configuration and the at least one key performance indicator are processed by a processing circuit. The processing circuit obtains a repeating scheduling pattern based on the network configuration and the at least one key performance indicator.

### FIELD OF THE DISCLOSURE

Embodiments of the present disclosure relate to a method of obtaining a repeating scheduling pattern for testing a device under test by a mobile communication tester. Furthermore, embodiments of the present disclosure relate to a method of conducting a test on a device under test by using a repeating scheduling pattern.

### BACKGROUND

All modern cellular mobile communication systems, e.g., GSM, WCDMA, LTE, NR, are slot based. Accordingly, there is a common time reference inside a cell and the time is divided into time slots. One of the fundamental actions of a base station in these communication systems is the scheduling, namely to decide in every time slot which user equipment (UE) shall transmit data (uplink-UL) and which user equipment shall receive data (downlink-DL). In some specific variations, for instance frequency divisional duplex (FDD) systems, some UEs may receive and transmit in the same time slot.

The respective scheduling strategy may be regarded as a function that considers the cell environment, namely the amount of data that the UEs want to transmit or the channel conditions associated with the UEs. Based thereon, the reception and/or transmission behavior of every UE is defined for every time slot. Additionally, the base station itself in the respective cell is also defined appropriately.

The base station of a real mobile communication system often employs a so-called dynamic scheduling, where the schedule can change in every time slot without repeating itself. The base station often considers—among others—the amount of data to transmit to a UE and/or receive from a UE, the channel state conditions or the Quality of Service (QoS) profiles.

In contrast thereto, a mobile communication tester, also called a “System Simulator” (SS), defines its scheduling often under a different premise. In some embodiments, many tests defined by standardization committees, e.g., 3GPP RAN4 or RAN5, are not dynamic in nature, but in fact follow a periodic repeating pattern. In other words, the mobile communication tester does not really take into account the amount of data to transmit or receive in order to compute the schedule, but often follows a periodic transmission/reception pattern.

The presence of uplink or downlink grants in a time slot is thus purely defined on the time and semi-static configuration parameters like the time divisional duplex (TDD) pattern, but not on dynamic quantities like the channel state information (CSI). These repeating scheduling patterns are also called “Reference Measurement Channels” (RMCs). One of the reasons to use repeating patterns instead of dynamic schedules is to allow reproducibility in the test, thereby ensuring to generate the same sequence of events if the test is repeated. Test reproducibility is a central aspect in a test and measurement system. The RMCs (and in general every repeating pattern) depend also on configuration parameters, for instance the chosen duplexing scheme (FDD, TDD or the TDD pattern or the presence of carrier aggregation).

A repeating scheduling pattern like an RMC is often the preferred choice for test setups, also due to the reproducibility of its results. However, the RMCs are typically only defined for some parameter sets. In many cases, there is no official RMC for several configuration parameters. Therefore, this gap has to be filled by manually defining suitable repeating scheduling patterns, which requires high development efforts and costs. This drawback becomes more severe since the mobile communication standards become more and more complex, e.g. 5G vs 4G vs 3G, as the number of potential configurations experiences a combinatorial-like explosion such that it is becoming increasingly hard to define these repeating schedules for every possible configuration.

Accordingly, there is a need for reducing the efforts required to obtain suitable repeating scheduling patterns for different network configurations, namely different configuration parameters.

### SUMMARY

Embodiments of the present disclosure provide a method of obtaining a repeating scheduling pattern for testing a device under test by a mobile communication tester. In an embodiment, the method comprises inputting a network configuration for performing a wireless communication test on the device under test, providing at least one key performance indicator (KPI), processing, by a processing circuit, the network configuration and the at least one key performance indicator, and obtaining, by the processing circuit, a repeating scheduling pattern based on the network configuration and the at least one key performance indicator.

The main idea is to cast the definition of the repeating scheduling pattern as a constrained optimization problem. In other words, the definition of the repeating scheduling pattern is left to the processing circuit that may be a constrained optimization solver, namely an optimizer circuit.

The implicit assumption is to allocate data in every time slot, i.e., to maximize the number of scheduled grants. However, scheduling can be seen as a decision problem, i.e., the allocation of data in a certain time slot can be represented as an optimization variable.

For instance, the mobile communication tester can decide in a time slot to schedule a grant or not and if yes with which modulation scheme, frequency allocation and so on.

A further key aspect is also to consider constraints due to the network configuration, e.g., a 3GPP specification, and also to consider the periodicity of the repeating scheduling pattern.

Generally, it is ensured that a customer's expectation is fulfilled according to which the test and measurement system shall work with whichever configuration. An example is a Callbox with carrier aggregation and carriers of different numerology. In these situations, the user typically expects the Callbox to just work, irrespective of the configuration changes that the user may execute during the tests. This expectation can be met due to the fact that the processing circuit processes the respective information inputted to obtain the repeating scheduling pattern. Hence, any changes made by the user during the tests are taken into account to adapt the repeating scheduling pattern appropriately.

Accordingly, information regarding the network configuration as well as the at least one key performance indicator are provided based on which the repeating scheduling pattern is determined. The processing circuit is programmed or otherwise configured to processes the information obtained, namely the network configuration and the at least one key performance indicator, thereby determining the repeating scheduling pattern which may be outputted for further processing, e.g., usage for testing the device under test by the mobile communication tester.

In some embodiments, the repeating scheduling pattern obtained may also be outputted to the user as a text file or in a graphical user interface (GUI).

Generally, the obtained repeating scheduling pattern ensures that tests on the device under test can be performed in a reproduceable manner, for example for different network configurations. Accordingly, a reference measurement channel can be provided based on the repeating scheduling pattern obtained.

An aspect provides that the repeating scheduling pattern is determined, for example, based on the network configuration and the at least one key performance indicator such that the at least one key performance indicator is optimized within boundaries provided by the network configuration. As indicated above, the constrained optimization problem is solved by the processing circuit that processes the network configuration and the at least one key performance indicator. The definition of the repeating scheduling pattern is left to the processing circuit. The scheduling can be seen as a decision problem, as the allocation of data in a certain time slot can be represented as an optimization variable. The processing circuit determines the repeating scheduling pattern, thereby optimizing the allocation of data in a certain time slot.

Another aspect provides that the user, for example, inputs the network configuration. This is done in any case by the user or rather customer when defining the test for the device under test.

In some embodiments, the processing circuit may be part of the mobile communication tester or a device associated with the mobile communication tester.

The user may manually interact with the mobile communication tester or the device associated with the mobile communication tester in order to input the network configuration.

Generally, the device associated with the mobile communication tester may be connected with the mobile communication tester such that the repeating scheduling pattern obtained is (automatically) forwarded to the mobile communication tester.

Alternatively, the repeating scheduling pattern itself may internally process the repeating scheduling pattern obtained for testing the device under test with respect to the repeating scheduling pattern.

According to another aspect, the network configuration is, for example, a semi static configuration pattern. This pattern may be selected by the user based on a default setting. Moreover, the semi static configuration pattern may be chosen via a script or via a graphical user interface (GUI).

For instance, the network configuration comprises a time divisional duplex (TDD) uplink/downlink pattern, number of carriers and/or numerologies of each carrier. Based on these configuration parameters, the repeating scheduling pattern may be determined by the processing circuit. Hence, the processing circuit takes those configuration parameters into account for determining the repeating scheduling pattern.

In some embodiments, the numerologies of each carrier comprise an Orthogonal Frequency-Division Multiplexing (OFDM) subcarrier spacing. The OFDM subcarrier spacing defines the characteristics of the channel used for testing. The channel is divided into subcarriers through a mathematical function known as an inverse fast Fourier transform (IFFT). The spacing of the subcarriers is orthogonal such that they do not interfere with each other even though guard bands are not provided between them.

A further aspect provides that the key performance indicator is, for example, at least one of a number of uplink grants in a scheduling period, a number of downlink grants in a scheduling period, an average grant-to-data-delay and a downlink throughput. These are typical key performance indicators (KPIs) by which the wireless communication can be characterized. As indicated above, at least one of these KPIs may be provided.

Generally, the processing circuit is programmed or otherwise configured to determine the repeating scheduling pattern such that the key performance indicator provided is optimized based on the network configuration provided. In other words, the network configuration defines the environment for the testing.

Moreover, a default key performance indicator may be provided by the mobile communication tester, which is taken into consideration when determining the repeating scheduling pattern. The default key performance indicator may be a standard KPI provided that the user does not manually set the key performance indicator. Accordingly, it is not necessary that the user selects a respective KPI, as at least one default KPI is set.

According to a further aspect, the determined repeating scheduling pattern is, for example, used by the mobile communication tester for testing the device under test. As mentioned above, the mobile communication tester itself may determine the repeating scheduling pattern and internally use the repeating scheduling pattern determined for testing the device under test. The user may interact with the mobile communication tester in order to provide the information necessary to determine the repeating scheduling pattern, e.g., the network configuration and the at least one key performance indicator.

For instance, the mobile communication tester simulates a base station. When testing the device under test, the mobile communication tester simulates the base station such that a channel for the device under test is simulated accordingly, e.g., a communication channel.

Another aspect provides that the processing circuit computes, for example, the repeating scheduling pattern. The repeating scheduling pattern is computed based on the information inputted rather than selected/chosen from a list of default repeating scheduling patterns. However, the computing may encompass adapting at least one default repeating scheduling pattern in order to arrive at the computed repeating scheduling pattern that is outputted or rather processed further, namely for testing the device under test.

The processing circuit may be programmed or otherwise configured to optimize the repeating scheduling pattern continuously or upon manual input. The further optimization of the repeating scheduling pattern may be done automatically, e.g., in a periodic manner in order to ensure that the repeating scheduling pattern is always updated. Alternatively, the repeating scheduling pattern may be optimized again in an automatic manner in case a manual interaction is sensed, for instance a manual input.

In some embodiments, the manual input is triggered by adapting the network configuration. In some embodiments, varying or rather changing the network configuration automatically triggers a new optimization of the repeating scheduling pattern, namely computing the repeating scheduling pattern again. Actually, varying or rather changing the network configuration results in different environmental conditions that may have an influence on the testing. Therefore, re-computing the repeating scheduling pattern ensures that the repeating scheduling pattern is still optimized even though the conditions have changed.

A further aspect provides that the processing circuit is, for example, capable of executing an Integer Linear Programming algorithm, a Tabu Search algorithm and/or a reinforcement learning algorithm for determining the repeating scheduling pattern. These algorithms are known optimization algorithms. The respective choice of optimization algorithm depends on the specific implementation as well as boundary conditions, e.g., computational power of the processing circuit.

For instance, the processing circuit may be programmed or otherwise configured to check the network configuration and/or the at least one key performance indicator with regard to contradictory. Therefore, it is verified by the processing circuit whether the information inputted can be processed in an appropriate manner or not. If it is not possible to process the information inputted can be processed in an appropriate manner, a contradictory has been determined by the processing circuit. For instance, the contradictory would lead to no throughput.

The processing circuit may be programmed or otherwise configured to verify if the network configuration inputted corresponds to an already standardized configuration. Hence, the processing circuit is capable to recognize whether the network configuration, e.g. the configuration parameters, match an already predefined one, namely an already standardized configuration, for instance a 3GPP-defined RMC.

In some embodiments, the processing circuit may be programmed or otherwise configured to obtain a standardized repeating scheduling pattern in case the processing circuit has verified that the network configuration inputted corresponds to the already standardized configuration. Hence, if a known RMC is found, this specific RMC will be used as the repeating scheduling pattern. Hence, the specific RMC corresponds to the obtained repeating scheduling pattern. However, if no known RMC is found, the processing circuit will generate its own repeating scheduling pattern, namely compute it accordingly.

Another aspect provides that the device under test is, for example, a user end device. The user end device may be a mobile phone, a tablet, a laptop or a notebook. Typically, these devices communicate with a base station in a wireless manner and, therefore, those devices are tested accordingly.

Generally, the method may be performed both online or offline. In an online mode, the user may control the processing circuit by an interactive user interface, for instance a graphical user interface (on a display connected with the processing circuit) or a web user interface. Thus, the network configuration can be changed on-the-fly by interacting with the respective user interface. Accordingly, the respective redefinition may be done during an ongoing test of the device under test. The processing circuit processes the input, for instance the adapted network configuration, and then redefines and adapts the repeating scheduling pattern.

In an offline mode, the user provides the network configuration, namely the configuration parameters, before the start of the test, the repeating scheduling pattern is computed before the test starts.

One or more embodiments of the methods disclosed herein ensure to automatically define a reference measurement channel for the mobile communication tester, also called wireless communication tester. Hence, it is not necessary to manually define the respective schedules which can be prone to errors and less flexible.

In some embodiments, the definition of the repeating scheduling pattern no longer depends on major development efforts, as it is reliably obtained for any network configuration. Therefore, the usability and stability of many applications and user interfaces for a mobile communication tester are improved.

Moreover, embodiments of the present disclosure also relate to a method of conducting a test on a device under test by using a repeating scheduling pattern. The repeating scheduling pattern is obtained by the method as described above. Therefore, the respective repeating scheduling pattern obtained may be used by the mobile communication tester for testing the device under test. Accordingly, the repeating scheduling pattern determined by the method of obtaining a repeating scheduling pattern, namely the result of the method, is used by the mobile communication tester in order to conduct a respective test on the device under test.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows a system capable of performing a representative method of obtaining a repeating scheduling pattern according to an embodiment of the present disclosure, and

FIG. 2 schematically shows an overview of an example repeating scheduling pattern obtained.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

Similarly, any steps described herein may be interchangeable with other steps, or combinations of steps, in order to achieve the same or substantially similar result. Moreover, some of the method steps can be carried serially or in parallel, or in any order unless specifically expressed or understood in the context of other method steps.

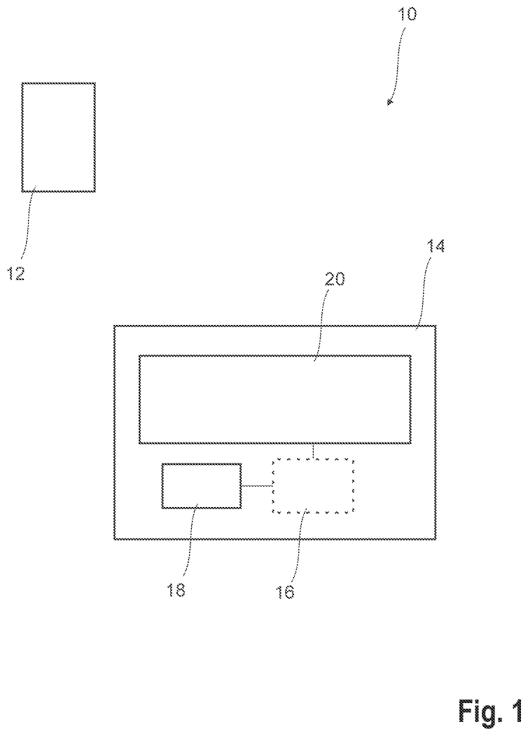

In FIG. 1, an example of a test and measurement system 10 for testing a device under test 12 is shown. In the embodiment shown, the system 10 comprises a mobile communication tester 14, also referred to as a wireless communication tester since the mobile communication tester 14 is used to test the characteristics of the device under test 12 with regard to its mobile/wireless properties.

In some embodiments, the device under test 12 is a user end device, for instance a mobile phone, a tablet, a laptop or a notebook, which is generally enabled to communicate in a wireless manner.

For testing the properties of the device under test 12, the mobile communication tester 14 simulates a base station that establishes a communication channel with the device under test 12. In some embodiments, a reference measurement channel is established by the mobile communication tester 14 which ensures a reproducibility of its results when testing the device under test 12.

In the shown embodiment, the mobile communication tester 14 comprises a processing circuit 16 that is connected with an input interface 18, for instance a user interface like a graphical user interface (GUI) or a web user interface (WebUI), via which a user is enabled to input information/data to be processed by the processing circuit 16. The mobile communication tester 14 also comprises an output interface 20 via which output data obtained, processed, etc., by the processing circuit 16 is outputted. For instance, the output interface 20 may be a display such that the output data is graphically outputted, namely displayed. Alternatively, the output data is outputted by a different data format, e.g. text data, for further processing.

In a certain embodiment, the input interface 18 and the output interface 20 may be established by the same display that has a graphical user interface which simultaneously provides the graphical input user interface and the graphical output user interface.

Alternatively to the shown embodiment, the system 10 may comprise a separately formed device that is connected with the mobile communication tester 14. The separately formed device may comprise the processing circuit 16. Moreover, the separately formed device may also comprise the input interface 18 and the output interface 20. The separately formed device may be connected with the mobile communication tester 14 via the output interface 20 such that the output data of the processing circuit 16 is forwarded to the mobile communication tester 14 via the output interface 20.

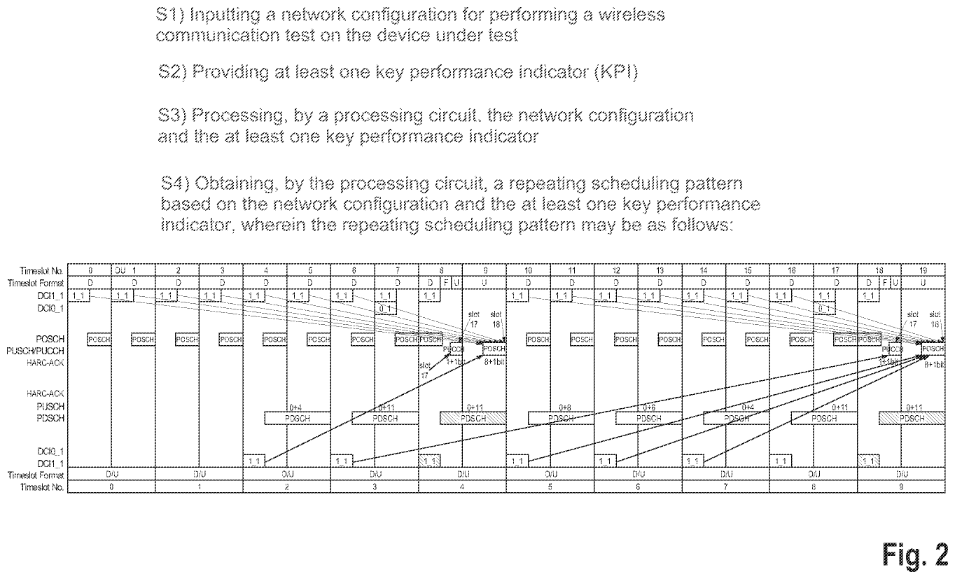

The system 10 is generally capable of performing a method, an example of which is shown in FIG. 2, namely a method of obtaining a repeating scheduling pattern, an example of which is shown in FIG. 2, for testing the device under test 12 by the mobile communication tester 14.

In a first step, a network configuration is inputted for performing a wireless communication test on the device under test 12, for instance via the input interface 18. In some embodiments, the user may interact with the input interface 18 in order to manually input the network configuration, namely configuration parameters, used for establishing the communication channel with the device under test 12 for testing purposes. The network configuration inputted may comprise a semi static configuration pattern or may be based on the semi static configuration pattern. Accordingly, the network configuration in some embodiments comprises a time divisional duplex (TDD) uplink/downlink pattern, number of carriers and/or numerologies of each carrier, namely an Orthogonal Frequency-Division Multiplexing (OFDM) subcarrier spacing.

Based on this configuration parameters, the mobile communication tester 14 may establish the communication channel that is used for testing the device under test 12.

In a second step, at least one key performance indicator (KPI) is provided. The KPI may be manually inputted by the user, namely via the input interface 18. Alternatively, a default key performance indicator is provided by the mobile communication tester 14 or the separately formed device comprising the processing circuit 16. Accordingly, it is not necessary that the user himself defines the respective KPI, as a default one can be set. However, the user is enabled to change the KPI or add at least one additional KPI if they so choose.

For instance, the KPI may be a number of uplink grants in a scheduling period, a number of downlink grants in a scheduling period, an average grant-to-data-delay and a downlink throughput. Hence, the number of uplink and/or downlink grants can be increased in a certain scheduling period. Additionally or alternatively, the downlink throughput can be increased.

The processing circuit 16 that is connected with the input interface 18 receives the information inputted, namely the networking configuration and optionally the KPI manually set. If no KPI is manually set, the default KPI is chosen, for example, automatically without manual input.

Then, the processing circuit 16 processes the network configuration and the at least one key performance indicator in order to obtain a repeating scheduling pattern. In other words, the processing circuit 16 is programmed or otherwise configured to determine the repeating scheduling pattern based on the network configuration and the at least one key performance indicator.

The processing circuit 16 is programmed or otherwise configured to determine the respective repeating scheduling pattern such that the at least one key performance indicator is optimized within boundaries provided by the network configuration. In some embodiments, the time divisional duplex (TDD) uplink/downlink pattern, the number of carriers and/or the numerologies of each carrier, namely the Orthogonal Frequency-Division Multiplexing (OFDM) subcarrier spacing, define(s) boundaries of the channel used for testing the device under test 12. The at least one key performance indicator shall be optimized within the boundaries provided by the configuration parameters mentioned above, e.g., the number of uplink/downlink grants.

In a first scenario, the processing circuit 16 verifies if the network configuration inputted corresponds to an already standardized configuration, e.g., an already defined scenario. In case the processing circuit 16 has verified that the network configuration inputted corresponds to the already standardized configuration, the processing circuit 16 obtains a standardized repeating scheduling pattern, namely an already defined one. This may be stored within a local memory, for example. Alternatively, the processing circuit 16 may communicate with a storage medium, e.g., a cloud-based storage medium, for instance via the Internet, a network connection or an Ethernet-connection. In this case, the processing circuit 16 can download the standardized repeating scheduling pattern, thereby obtaining the repeating scheduling pattern.

In a second scenario, the processing circuit 16 computes the repeating scheduling pattern based on the information inputted, namely the network configuration and the at least one key performance indicator, for instance based on an already existing repeating scheduling pattern.

When computing the repeating scheduling pattern, an optimization problem may be constrained and solved, wherein the allocation of data in a certain time slot is represented as an optimization variable. Therefore, the processing circuit 16 may relate to a constrained optimization solver, namely an optimizer circuit.

Accordingly, the processing circuit 16 may be programmed or otherwise configured to execute an Integer Linear Programming algorithm, a Tabu Search algorithm and/or a reinforcement learning algorithm for determining the repeating scheduling pattern. These known algorithms are used for solving optimization problems. The intended algorithm depends on the specific implementation and boundary conditions like computational power of the processing circuit 16.

The processing circuit 16 determines the repeating scheduling pattern that provides the optimized key performance indicator (KPI) provided previously, namely with regard to the specific network configuration set.

Moreover, the processing circuit 16 optimizes or re-calculates the repeating scheduling pattern continuously or upon manual input, for instance due to adapting the network configuration. In other words, the user may adapt the network configuration, thereby triggering the automatic re-calculation of the repeating scheduling pattern.

In any case, the processing circuit 16 further checks the network configuration and/or the at least one key performance indicator with regard to contradictory. In some embodiments, it is checked whether any inputted data/information causes a contradiction, for instance a throughput of zero.

Once the processing circuit 16 has determined the repeating scheduling pattern, the repeating scheduling pattern is used by the mobile communication tester 14 for testing the device under test 12.

As shown in FIG. 1, the mobile communication tester 14 itself comprises the processing circuit 16 such that the mobile communication tester 14 internally processes the information/data provided, namely the network configuration inputted and the (default) key performance indicator, in order to obtain the repeating scheduling pattern.

Alternatively, the separately formed device, which comprises the processing circuit 14, obtains the repeating scheduling pattern that is outputted forwarded to the separately formed mobile communication tester 14 that uses the repeating scheduling pattern for testing the device under test 12.

In addition to using the repeating scheduling pattern obtained for testing the device under test 12, the repeating scheduling pattern obtained may also be outputted to the user, for instance via the output interface 20, as a text file or in the graphical user interface (GUI).

The methods provided herein may be performed both online or offline.

In an online mode, the user may control the processing circuit 16 by the input interface 18. Hence, the network configuration can be changed on-the-fly by interacting with the respective input interface 18. Accordingly, a redefinition of the network configuration may be done during an ongoing test of the device under test 12. The processing circuit 16 processes the adapted network configuration in order to recalculate the repeating scheduling pattern.

In an offline mode, the user provides the network configuration, namely the configuration parameters, before testing the device under test 12. Hence, the repeating scheduling pattern is computed before the testing the device under test 12.

Embodiments of the methods disclosed herein ensure to automatically define the reference measurement channel for the mobile communication tester 14, thereby ensuring reliable tests of the device under test 12 for different network configurations with less efforts and, thus, in an cost-efficient manner.

Afterwards, the mobile communication tester 14 uses the repeating scheduling pattern obtained for testing the device under test 12. Hence, the respective test is performed based on the repeating scheduling pattern obtained as discussed above. In some embodiments, it is ensured that the device under test 12 can be tested based in an appropriate manner.

In some embodiments, the repeating scheduling pattern may be used during an ongoing test, e.g., during a test campaign. Hence, testing the device under test 12 based on the repeating scheduling pattern obtained may relate to a certain test of several tests of a test campaign. In some embodiments, it is also possible to alter the repeating scheduling pattern during the test campaign as discussed above by adapting the configuration parameters. Consequently, the test campaign may also encompass more than one test that is based on the repeating scheduling pattern(s) obtained.

Certain embodiments disclosed include components, such as the processing circuit 16, the input interface 18, the output interface 20, etc., utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof.

In an embodiment, circuitry includes hardware circuit implementations (e.g., implementations in analog circuitry, implementations in digital circuitry, and the like, and combinations thereof). In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an one or more processors or portions thereof and accompanying software, firmware, hardware, and the like.

In some examples, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein, carrying out one or more of the steps of method claims provided below, etc.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

Throughout this specification, terms of art may be used. These terms are to take on their ordinary meaning in the art from which they come, unless specifically defined herein or the context of their use would clearly suggest otherwise.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A method of obtaining a repeating scheduling pattern for testing a device under test by a mobile communication tester, wherein the method comprises the steps of:
inputting a network configuration for performing a wireless communication test on the device under test,
providing at least one key performance indicator (KPI),
processing, by a processing circuit, the network configuration and the at least one key performance indicator, and
obtaining, by the processing circuit, a repeating scheduling pattern based on the network configuration and the at least one key performance indicator.

2. The method according to claim 1, wherein the repeating scheduling pattern is determined based on the network configuration and the at least one key performance indicator such that the at least one key performance indicator is optimized within boundaries provided by the network configuration.

3. The method according to claim 1, wherein the user inputs the network configuration.

4. The method according to claim 1, wherein the network configuration is a semi static configuration pattern.

5. The method according to claim 1, wherein the network configuration comprises a time divisional duplex (TDD) uplink/downlink pattern, number of carriers and/or numerologies of each carrier.

6. The method according to claim 5, wherein the numerologies of each carrier comprise an Orthogonal Frequency-Division Multiplexing (OFDM) subcarrier spacing.

7. The method according to claim 1, wherein the key performance indicator is at least one of a number of uplink grants in a scheduling period, a number of downlink grants in a scheduling period, an average grant-to-data-delay and a downlink throughput.

8. The method according to claim 1, wherein a default key performance indicator is provided by the mobile communication tester, which is taken into consideration when determining the repeating scheduling pattern.

9. The method according to claim 1, wherein the determined repeating scheduling pattern is used by the mobile communication tester for testing the device under test.

10. The method according to claim 1, wherein the mobile communication tester simulates a base station.

11. The method according to claim 1, wherein the processing circuit computes the repeating scheduling pattern.

12. The method according to claim 1, wherein the processing circuit optimizes the repeating scheduling pattern continuously or upon manual input.

13. The method according to claim 12, wherein the manual input is triggered by adapting the network configuration.

14. The method according to claim 1, wherein the processing circuit is capable of executing an Integer Linear Programming algorithm, a Tabu Search algorithm and/or a reinforcement learning algorithm for determining the repeating scheduling pattern.

15. The method according to claim 1, wherein the processing circuit checks the network configuration and/or the at least one key performance indicator with regard to contradictory.

16. The method according to claim 1, wherein the processing circuit verifies if the network configuration inputted corresponds to an already standardized configuration.

17. The method according to claim 16, wherein the processing circuit obtains a standardized repeating scheduling pattern in case the processing circuit has verified that the network configuration inputted corresponds to the already standardized configuration.

18. The method according to claim 1, wherein the device under test is a user end device.

19. A method of conducting a test on a device under test by using a repeating scheduling pattern, wherein the repeating scheduling pattern is obtained by the method according to claim 1.
